(19) United States
(12) Patent Application Publication
(10) Pub. No.: US 2021/0350041 A1
(43) Pub. Date: Nov. 11, 2021

(54) PARAMETRIC PROCESS FOR DESIGNING AND PRICING A PHOTOVOLTAIC CANOPY STRUCTURE WITH EVOLUTIONARY OPTIMIZATION

(71) Applicant: Benjamin Lepley, Tucson, AZ (US)

(72) Inventor: Benjamin Lepley, Tucson, AZ (US)

(21) Appl. No.: 17/189,046

(22) Filed: Mar. 1, 2021

Related U.S. Application Data
(60) Provisional application No. 62/983,984, filed on Mar. 2, 2020.

(51) Int. Cl. G06F 30/13; G06Q 10/06; G06Q 50/08; G06F 30/27; G06F 16/245; G01W 1/12; H02S 20/10

(52) U.S. Cl. CPC G06F 30/13; G06Q 10/06313; G06Q 50/08; G06Q 10/0875; G06F 16/245; G01W 1/12; H02S 20/10; G06F 30/27

(57) ABSTRACT

Systems and methods for automating design of photovoltaic installations for placement on a selected site receive geographical information describing the site that includes areas of the site which must be spanned by support structures carrying photovoltaic panels such as canals, trenches, roads, arenas, and other features. An initial structure design which meets supplied requirements for energy production and as well as economic constraints is produced using elements produced by varying characteristics of predefined template structures. Genetic optimization of the initial design is performed to optimize dimensions of the structural elements and structural material choices to produce a structure that optimizes a fitness metric such as the levelized cost of energy.

### CROSS-REFERENCE TO RELATED APPLICATIONS

This application claims the benefit of U.S. Provisional Patent Application No. 62/983,984, filed Mar. 2, 2020 and entitled “Parametric Process For Designing And Pricing A Photovoltaic Canopy Structure With Evolutionary Optimization,” the disclosure of which is incorporated by reference herein in its entirety.

### STATEMENT REGARDING FEDERALLY-FUNDED RESEARCH AND DEVELOPMENT

This invention was made with government support under DE-SC0020022 awarded by the United States Department of Energy. The government may have certain rights in the invention.

### BRIEF SUMMARY

Disclosed herein are systems and methods to streamline and expedite the process of designing and evaluating photo-voltaic projects that span across open spaces on the basis of structure cost, system cost, site cost, and projected income from power sales. Current structural or solar design systems used do not actively maximize power output while minimizing structural cost. The workflow is intended to work with a variety of structural typologies and also using existing evaluation metrics.

An example embodiment provides a system for designing an optimized structure supporting photovoltaic panels for placement at a selected site. The system includes a processor and memory. The memory stores executable instructions. Execution of the instructions by the processor causes the system to receive an energy output specification indicating a desired minimum level of electrical energy to be produced by the photovoltaic panels and receive geographic information for the selected site that indicates portions of the selected site to be spanned by the optimized structure and historical climate data for the selected site; generate an initial system design; calculate a value of a fitness score for the initial system design; and perform genetic optimization of the initial system design to determine an optimized system design to support the photovoltaic system. The optimized system design has a value of the fitness score that is less than the value of a fitness score for the initial system design.

The system generates the initial system design by selecting, for each portion of the selected site to be spanned, a structure design template describing a first structure type suitable for spanning that portion of the selected site; determining, for each portion of the selected site to be spanned, dimensions of a respective structural unit of having the first structure type, suitable to span that portion of the selected site; determining a corresponding arrangement of photovoltaic panels mountable on each respective structural unit capable of providing the desired minimum level of electrical energy at the selected site while mounted on the respective structural units; calculating estimated structural loading of each respective structural unit when supporting the corresponding arrangement of photovoltaic panels for that structural unit; and determining materials for each respective structural unit required to support the arrangements of photovoltaic panels for that structural unit.

The system calculates the value of the fitness score for the initial system design by calculating, using the geographic information and the historical climate data for the selected site, a total expected energy output for the initial system design by summing expected energy outputs of the arrangements of photovoltaic panels for each portion of the selected site to be spanned according to the initial system design; calculating an expected cost of constructing the initial system design; and producing, as the value of the fitness score for the initial system design, a numerical score representing a ratio of the expected cost of constructing the initial design to the total expected energy output for the initial system design.

In one embodiment, when execution of the instructions by the processor causes the system perform the genetic optimization of the initial system design, the system performs a modification procedure. The modification procedure includes varying a dimension or position of one or more component of at least one structural component belonging to one or more structural unit of the initial system design to produce a modified system design; calculating a value of the fitness score for the modified system design; and repeatedly performing the modification procedure using the modified system design in place of the initial system design.

Calculating the value of the fitness score for the modified system design includes calculating, using the geographic information and the historical climate data for the selected site, a total expected energy output for the initial system design by summing expected energy outputs of the arrangements of photovoltaic panels for each portion of the selected site to be spanned according to the modified system design; calculating, an expected cost of constructing the modified system design; and producing, as the value of the fitness score for the modified system design, a numerical score representing a ratio of the expected cost of constructing the initial design to the total expected energy output for the initial system design.

Another example embodiment provides a computer-implemented method for designing an optimized structure supporting photovoltaic panels for placement at a selected site. The method includes receiving an energy output specification indicating a desired minimum level of electrical energy to be produced by the photovoltaic panels; receiving geographic information for the selected site that indicates portions of the selected site to be spanned by the optimized structure and historical climate data for the selected site; generating an initial system design; calculating a value of a fitness score for the initial system design; and performing genetic optimization of the initial system design to determine an optimized system design to support the photovoltaic system, the optimized system design having a value of the fitness score that is less than the value of a fitness score for the initial system design. The optimized system design has a value of the fitness score that is less than the value of a fitness score for the initial system design.

Generating the initial system design includes selecting, for each portion of the selected site to be spanned, a structure design template describing a first structure type suitable for spanning that portion of the selected site; determining, for each portion of the selected site to be spanned, dimensions of a respective structural unit of having the first structure type, suitable to span that portion of the selected site; determining a corresponding arrangement of photovoltaic panels mountable on each respective structural unit capable of providing the desired minimum level of electrical energy at the selected site while mounted on the respective structural units; calculating estimated structural loading of each respective structural unit when supporting the corresponding arrangement of photovoltaic panels for that structural unit; and determining materials for each respective structural unit required to support the arrangements of photovoltaic panels for that structural unit.

Calculating the value of the fitness score for the initial system design includes calculating, using the geographic information and the historical climate data for the selected site, a total expected energy output for the initial system design by summing expected energy outputs of the arrangements of photovoltaic panels for each portion of the selected site to be spanned according to the initial system design; calculating an expected cost of constructing the initial system design; and producing, as the value of the fitness score for the initial system design, a numerical score representing a ratio of the expected cost of constructing the initial design to the total expected energy output for the initial system design.

In one embodiment, performing the genetic optimization of the initial system design includes performing a modification procedure. The modification procedure includes varying a dimension or position of one or more component of at least one structural component belonging to one or more structural unit of the initial system design to produce a modified system design; calculating a value of the fitness score for the modified system design; and repeatedly performing the modification procedure using the modified system design in place of the initial system design.

Calculating the value of the fitness score for the modified system design includes calculating, using the geographic information and the historical climate data for the selected site, a total expected energy output for the initial system design by summing expected energy outputs of the arrangements of photovoltaic panels for each portion of the selected site to be spanned according to the modified system design; calculating, an expected cost of constructing the modified system design; and producing, as the value of the fitness score for the modified system design, a numerical score representing a ratio of the expected cost of constructing the initial design to the total expected energy output for the initial system design.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a flow diagram illustrating an example process for optimizing the design of a photovoltaic (PV) installation on a selected site including areas which must be spanned by structural units supporting photovoltaic panels.

FIGS. 2A-2G show perspective and elevation views of several types of structures that may be produced by an example system;

FIG. 3 is an illustration of different PV panel configurations and related variables;

FIG. 4 is an illustration of an empty site rectangle with dimensions and example sun obstructions at the site;

FIG. 5 is an illustration of weather data which may be used in embodiments herein including data diagram, temp, snow, cloud cover, trends;

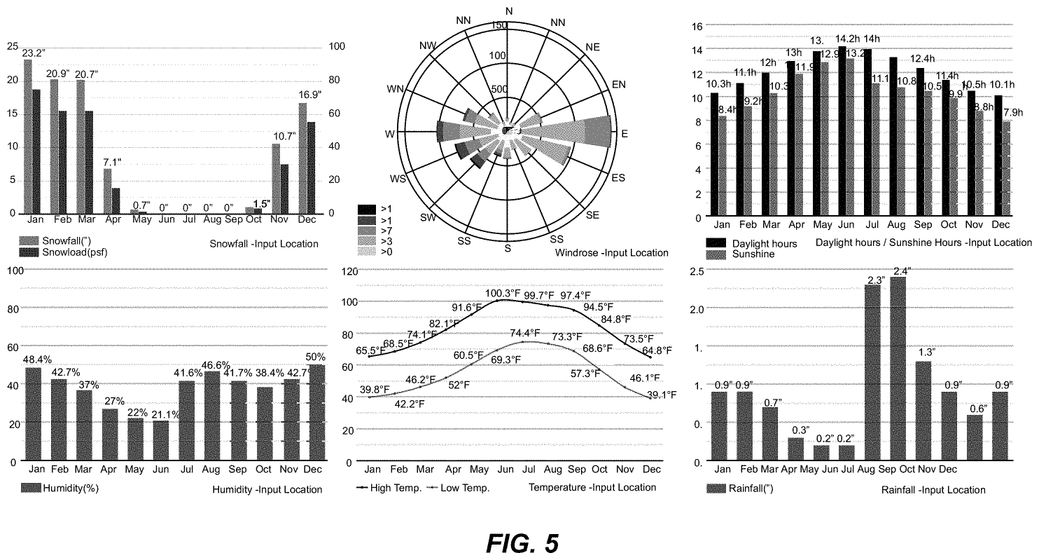

FIG. 6 is an illustration including a dome diagram of latitude and longitude and an illustration of the sun's position in the sky related to an example PV array at the coordinates shown;

FIGS. 7A-7C show perspective views and section views of two example structural units: a “basic” structure (7A), a “thin shell” structure (7B). FIG. 7C shows a “sawtooth” array of thin shell structures.

FIG. 8 is an exploded perspective view of a thin-shell arch structural unit showing PV panels, wiring, structural sheet steel elements, tension cables, columns, and beams as installed on a site.

FIGS. 9A-9C are perspective and section views of an example tension structure, an example bowstring structure, and an example sawtooth structure;

FIG. 10 is a detail view of individual Panels being able to tilt along an axis to face the sun

FIG. 11 is a detail view of individual structural units with the ability to be added to or reduced in a modular manner

FIG. 12 is a top view of self-shading modular optimizer sample output for step 600 of the process of FIG. 1 applied to the structure type of FIG. 2D

FIG. 13 is an example system wiring diagram demonstrating an output at step 650 of the process of FIG. 1 applied to structure type of FIG. 2C

FIG. 14 is an example system wiring diagram

FIG. 15 is a UML diagram of stress equation, structural selection, and pricing.

FIG. 16 is an example structural flange size

FIG. 17 illustrates an example load equation; and

FIG. 18 is an illustration of an example database of flange beams or columns.

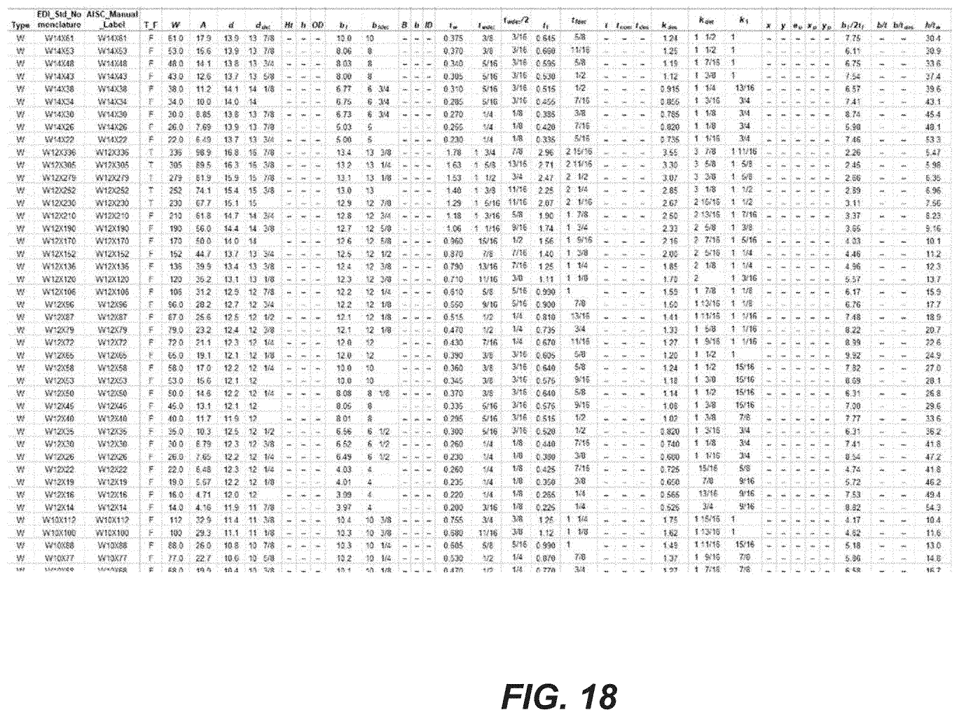

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Disclosed herein are systems and methods capable of analyzing economic factors, structural components, and manipulating geometries of a photovoltaic (PV) structural system configured to span an open space, and generate an optimized system design with the lowest final Levelized Cost of Energy (LCOE) or any other suitable fitness metric. Embodiments disclosed herein are applicable to structures and energy systems that designed to span over an open space such as a road, canal, stadium, or large room that also produces electricity from photo-voltaic panels affixed to the structure. Embodiments disclosed herein balance the cost of the structure, land price, power generation value, financing costs, operations, and maintenance costs together to find the optimal configuration for the given inputs. Any change in one input may cause the other inputs to be optimized automatically based on the lowest LCOE possible. This optimization can be through an evolutionary solving process which compares all possible variable inputs and narrows down to the lowest LCOE by incremental deductive variability solving (stochastic solving). After a sufficient number of conditions have been tested and process, their results can be used as a training data set for a neural network, thus decreasing computation time.

Embodiments disclosed herein may also optimize alternative metrics such as cost of energy per Watt, as a non-limiting example. The energy per Watt metric eliminates the factor of time such as O/M and PWF (Present Worth Factor), such that the nameplate energy production capacity is divided by the initial cost of the system.

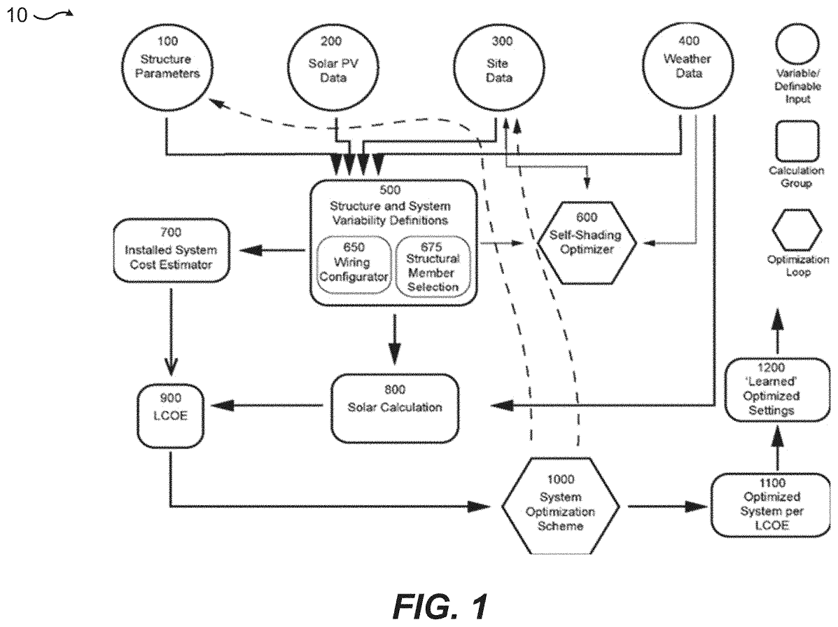

FIG. 1 is a flow diagram illustrating an example process 10 according to embodiments herein. The process 10 includes the steps 100, 200, 300, 400, 500, 600, 700. 800, 900, 1000, 1100, and 1200 as described further below.

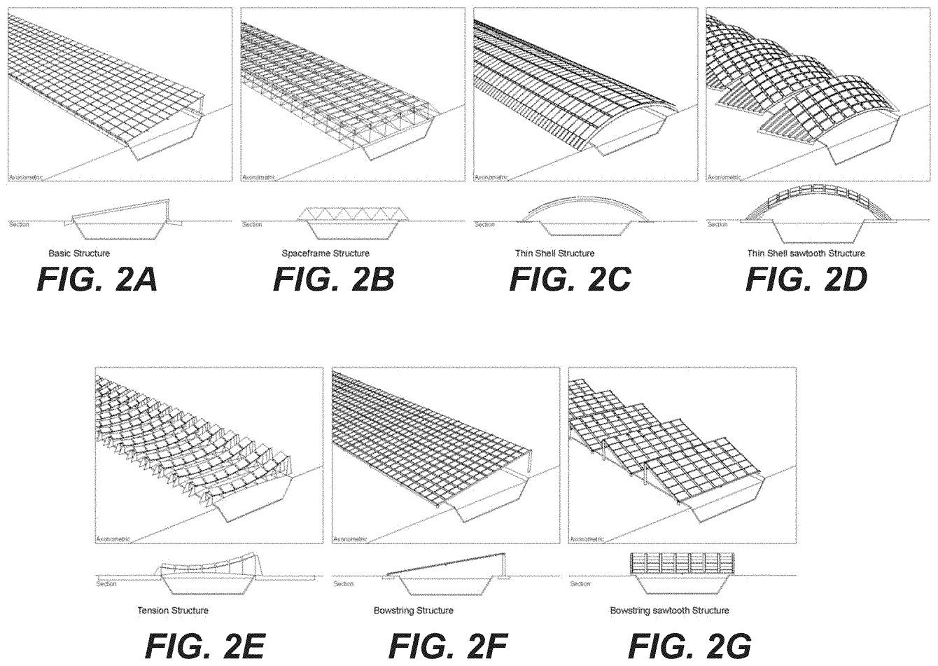

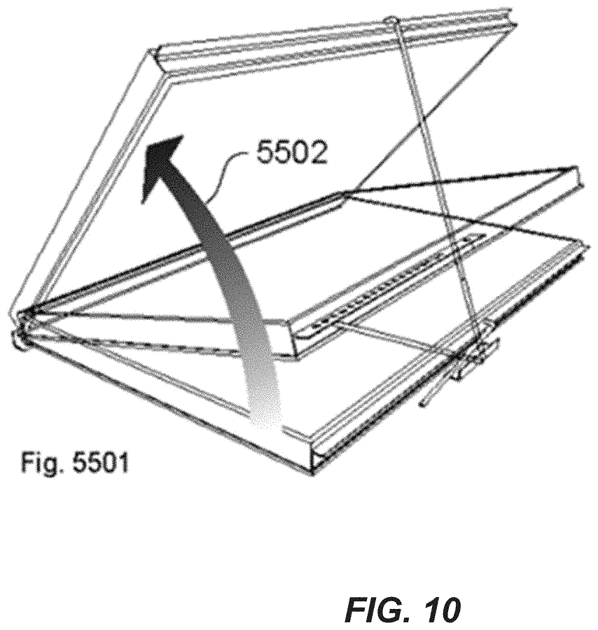

Step 100: Initial Structural Geometry input. The initial structural geometry can be almost any structural system capable of spanning over an open space, made up of discrete structural pieces connected together as a system. Seven such structures are shown in FIG. 2 as examples. Such a system must support itself resisting live and dead loads and also support photovoltaic panels. These initial structural systems are designed using structure design templates that accommodate numerous geometrical permutations that can change at minimum, the height, structural span. structural module size, interior and exterior clearances, canopy tilt, PV panel angle and tilt, and electrical system layout. The potential initial structural design inputs are theoretically endless. The structures can span in a singular X direction, (see FIG. 10) or both X and Y directions. A modular system that repeats to form a chain, grid, mesh, is also a valid input. Each discrete structural member, such as an I-beam, tube, or cable must have the capability of being sized according to change in stresses based on the span, or other loads. The initial structural input may not be just a catalog of parts, i.e., the initial structural input may be a pre-assembled system with specific corresponding structural relationships that are ready to be manipulated by the next steps of the process.

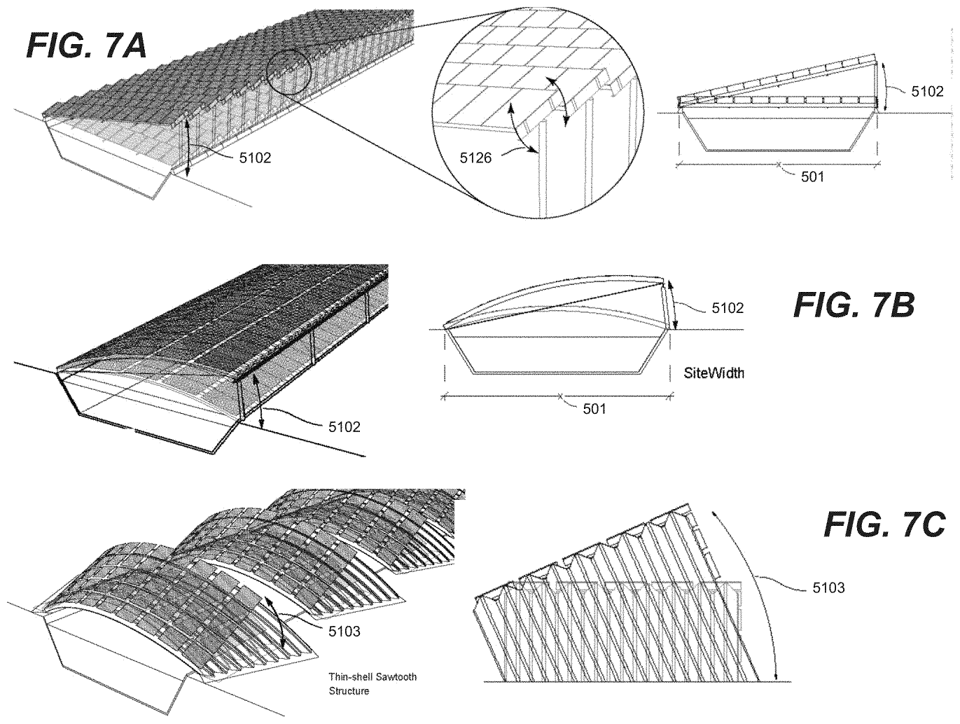

Example structural geometries. The example structure design templates listed below are suitable for use with for systems and methods disclosed herein and may be implemented directly with variables these methods define and adjust:
1. A thin-shell arch “Quonset hut” structure (see FIGS. 2C and 7B) that has the ability to tilt on one axis as to optimize for sun exposure (see the rotation path 5102 of FIG. 7B).
2. A thin-shell arch “Quonset hut” structure that has the ability to tilt on two axis (see

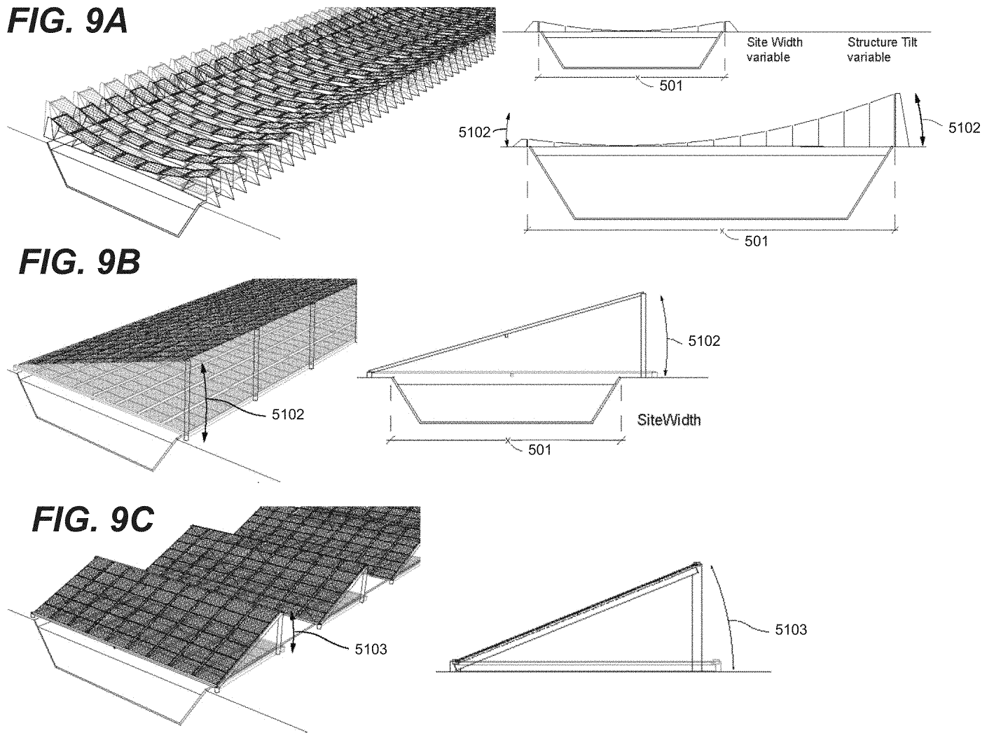

FIGS. 2D and 7C) as to optimize for sun exposure (see the rotation paths 5102, 5103 of FIG. 7C)
3. A tensile structure (see FIGS. 2E and 9A) where the primary structural component is made of interconnected metal linked frames or beams that bend at their joints suspended between the two sets of the main support columns. Directly or through a racking structure solar panels are mounted onto the links.
4. A hybrid rigid and tensile structure (see FIGS. 2F and 9B) made of a rigid frame steel frame comprised of primary spanning girders attached the columns spanning in X direction with tension cables spanning Y direction, attached at each end to the primary spanning girders whose tension is resolved compressive struts made of tubes, I-Beams, or other metal, wood, or composite structural members spanning in Y direction, connected to the primary girders. The structure is designed to tilt along the axis 5102 as shown in FIG. 9B. Solar panels held on with cups, brackets, or racking system, attached directly to the tension cables.
5. A hybrid rigid and tensile structure (see FIGS. 2G and 9C) as in FIG. 9B but modified to tilt along the axis 5103 shown in FIG. 9C.

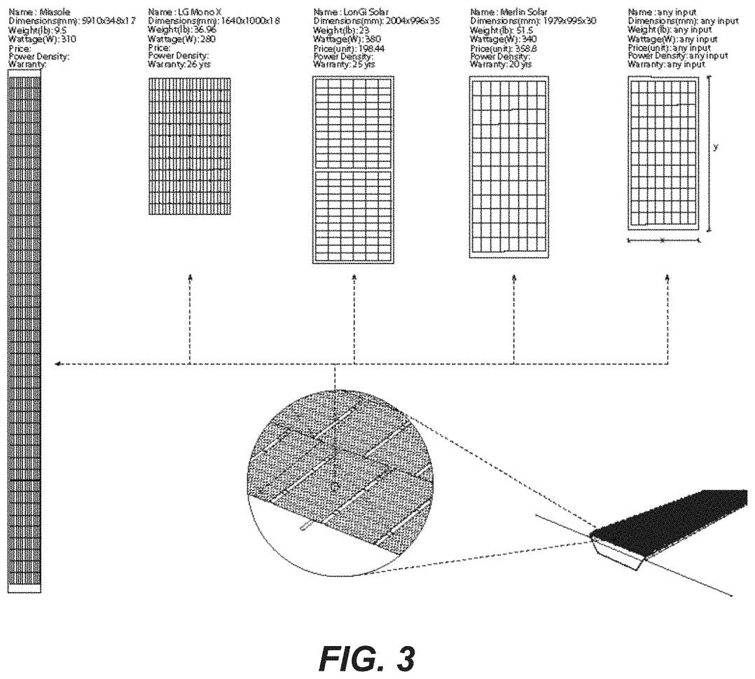

Step 200: Solar PV Data. At this step, the system retrieves input specific characteristics of the solar panels themselves such as weight, dimensions, mounting points, operating voltage and wattage, lifetime degradation behavior, energy generation, price, nameplate rating, as non-liming examples, as illustrated by FIG. 3. The PV system data may be a comprehensive list formatted in a machine readable format such the system may select different panels as part of the genetic optimization process to identify an optimal balance of power density, price, lifespan, and weight.

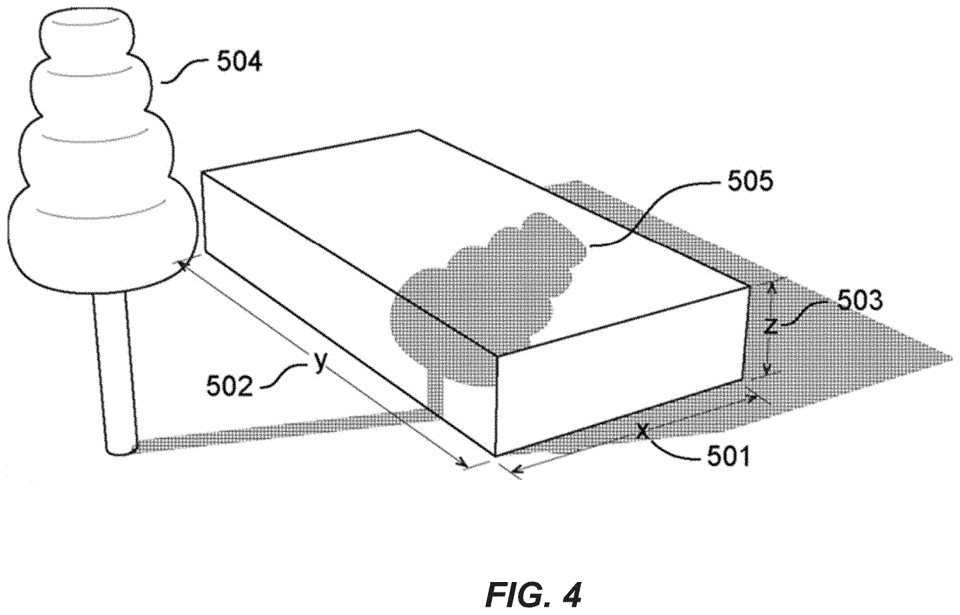

Step 300: Site Data input. The site data contains site-specific information for which the structure will accommodate. The following parameters should be included, Latitude and Longitude, site size with required setbacks, soil bearing capacity, largest PSF loading of either wind, seismic, snow, or live and dead loads, and clearances needed under, beside, underneath, or over the structure. Site information that identifies objects that may cast a shadow on the site 505 as shown in FIG. 4 may also be input, such as surrounding trees, building, or ground topography.

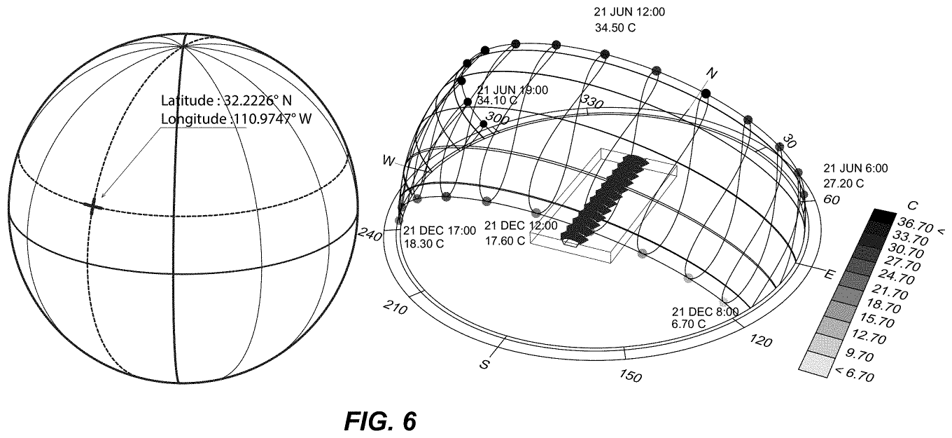

Step 400; Weather Data input. The local historical weather data may be input in a standardized format such as an .epw file format. Weather data may include historical seasonal shifts such as cloud cover, sun position, temperature, precipitation, snow depth, wind direction and speed, haze, sun radiance intensity, and humidity, as non-limiting examples. See FIG. 6. The geo-coordinates and elevation of the site may also be contained to allow calculating the precise position of the sun. The sun position is critical in optimizing PV panel tilt and spacing. The aggregate weather data is important in calculating energy production seasonally and yearly.

Step 500: Structure geometry variability definitions and Structural sizing. At this step, the system uses a variability engine that receives the data acquired at steps 100, 200, 300, & 400. At step 100 the acceptable ranges of variation for each structure design template are received. These ranges may be modified later as the result of a genetic optimization process at step 1000.

As above, step 100 is the initial step in the process 10, wherein the system receives structure design templates as inputs (see FIGS. 2A-2G as examples). In various embodiments, a selected site with an area (or areas) to be spanned (such as canals or trenches, as non-limiting examples) may be spanned with a single structural unit (by adjusting a structure design template to span the entire area to be spanned), an array of structural units having a single structure type (i.e., designed using the same template), or a combination of structural units having different structure types (i.e., designed using different structure design templates).

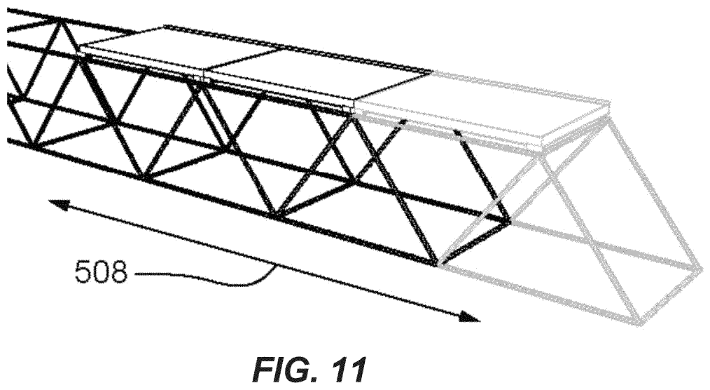

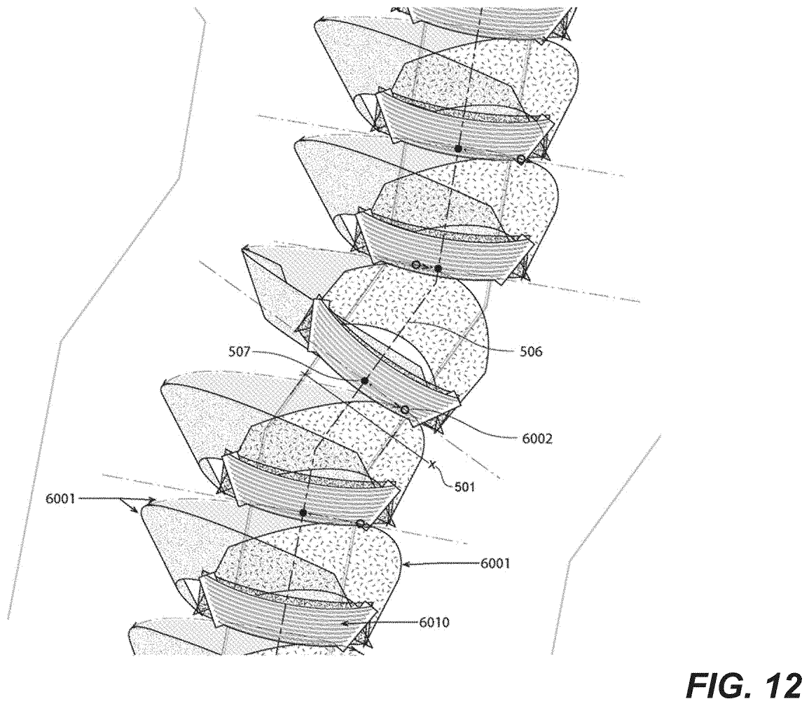

The second step in this example process is to modify the structure to stretch over the given site dimensionally as per their pre-designed geometrical variables such as site width 501, site length 502, and site clearance 503, as illustrated in FIG. 12. As part of this process a centerline is created 506 with corresponding base-point 507 which is used for modular structure orientation. The input structures adjust in two ways, one is by a modular addition 508 of the structure cell itself (see FIG. 11 for example), and also by elongating the individual beams, cables, and other structural pieces as defined in the input at step 100.

The third step in this example process is transforming the structure so the solar panels atop face towards the sun at the optimal angle according to geographic data input in module 400. Each structure type input may have one or two degrees of rotation or transformation in which to accommodate the optimal sun angle. The tilt can be implemented on structure-wide scale 5102, sub-structure scale 5103 row-scale 5126, or on an individual panel basis 5502

Step 600: Self-Shading Optimizer. This sub-process fixes any self-shading that might occur with a tilt such as 5103, 5125, or 5502. Self-shading is when a panel or set of panels casts a shadow on a set of panels behind which reduces energy production and increases the LCOE. To fix this, a shadow detection sub-module detects and automatically spaces panels or sets of panels to the optimal spacing. This module works recursively starting on the panel set closest to the equator, working backwards along a centerline 506, as shown in FIG. 12. Using the winter solstice sun position (or other defined position), the edge of the shadow is traced upon a horizontal flat plane whose level is set to the lowest portion of any solar panel 6001. The farthest tangential point away from equator 6002 that line intersects the centerline becomes the basepoint point 507 for the next panel or group of panels, as shown in FIG. 12.

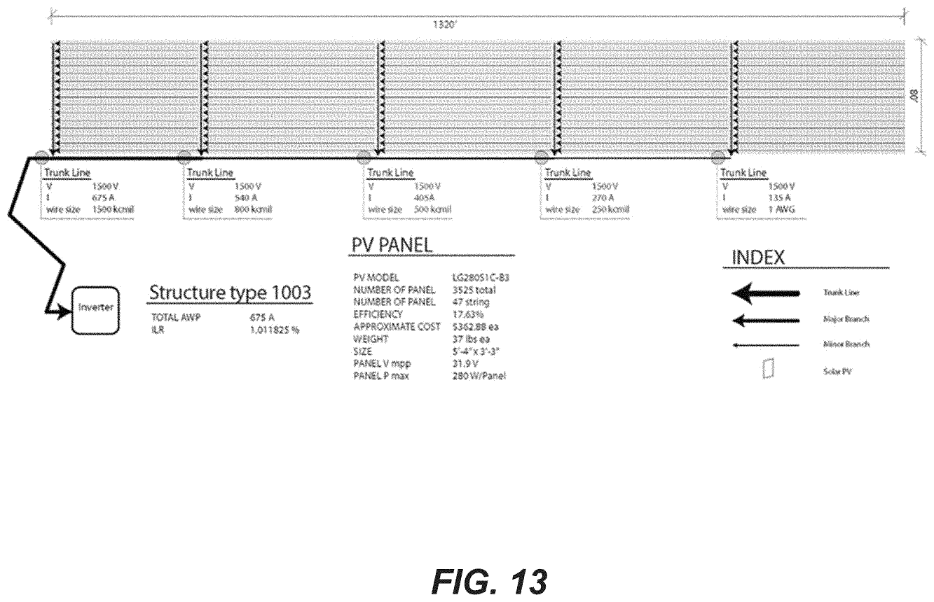

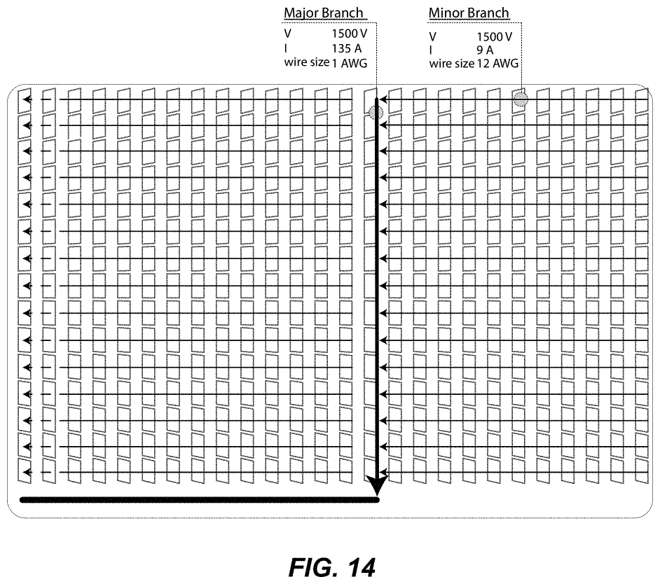

Step 650: Wiring configuration. At this sub-step of step 500, the system creates a wiring layout based on the resulting solar panel layout. See FIG. 13 for an example wiring layout. Wiring voltage, wattage, wire gauge, number of panels per series string, and number of parallel branches may be automatically assigned and correspond to the defined inverter and solar panel specifications. For example, if the selected central inverter requires 1600V DC, a row of panels will be connected in series until their input voltage adds up but not exceeds 1600V DC resulting in a full string of panels which can then be connected in parallel to the inverter. See FIG. 14.

Maximizing the voltage of the series panel wires allows the wire gauge to stay at a minimum, saving wiring costs. Series-type wiring should connect together panels in a string that have the same power generation output based on their orientation and shading. If it is not possible to wire a string of similar panels together, a second wiring option is also possible, where panels that feature micro-inverters are wired in parallel at 240v, this might use more copper wire, but allows more complex geometry and power output variables for each panel.

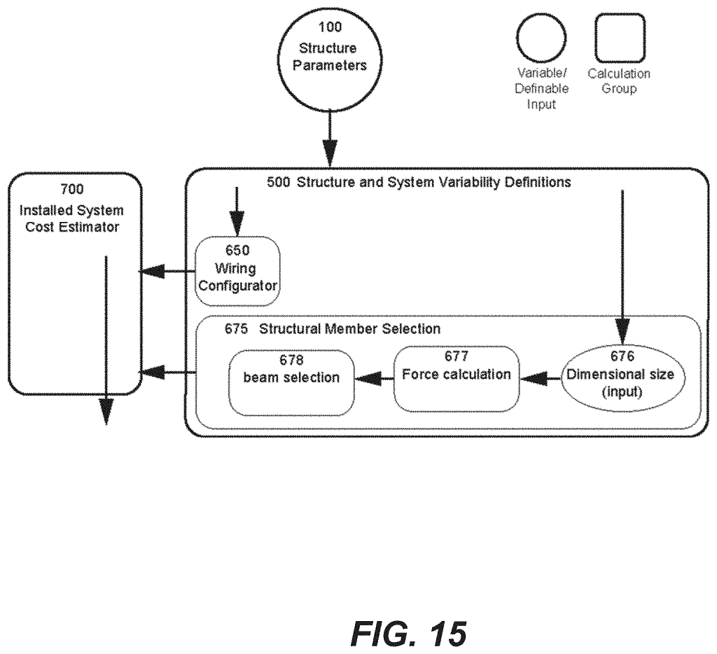

Step 675: Structural Member sizing and selection. In some embodiments, each structure design template received at step 100 is made up of a series of structural members that have a pre-defined range of sizes and stresses. This pre-loaded definition database may limit the design variables down to a list that is predictable and easily processed at step 1000 using a system optimization scheme. FIG. 15 is a UML diagram showing the following sub-steps in the process: generating changed structural element sizes (676), calculating structural forces (677), and selecting the lightest beam or column within a specified margin of safety (678). These variables are defined at a minimum and maximum of loads and site sizes that would be reasonably predicted. For example a structural force range and dimension range could start at 20 PSF and 20 feet of span and go up to 80 PSF and 200 feet of span. The structural typology is pre-engineered to determine, what the stress ranges are for each structural member.

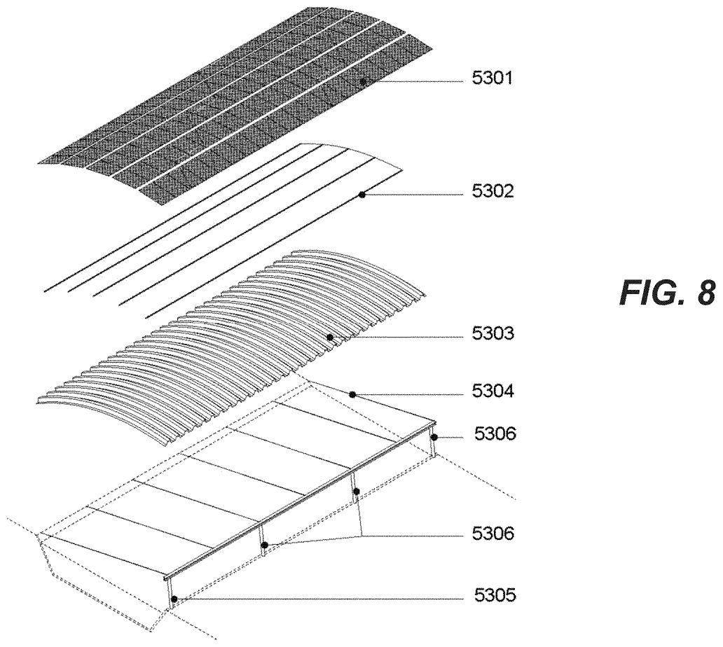

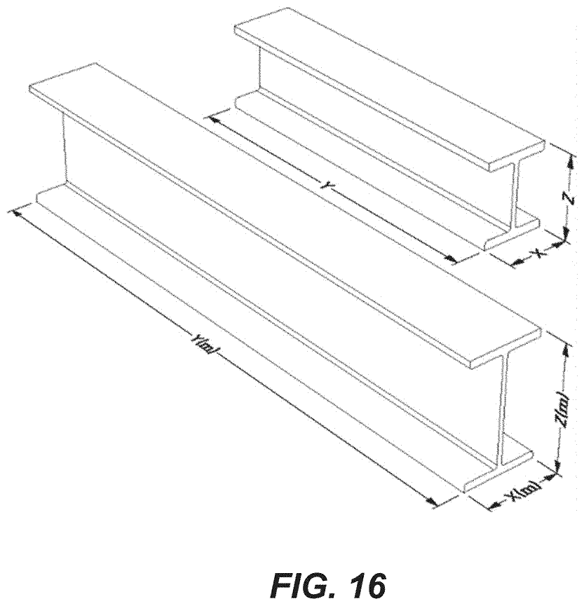

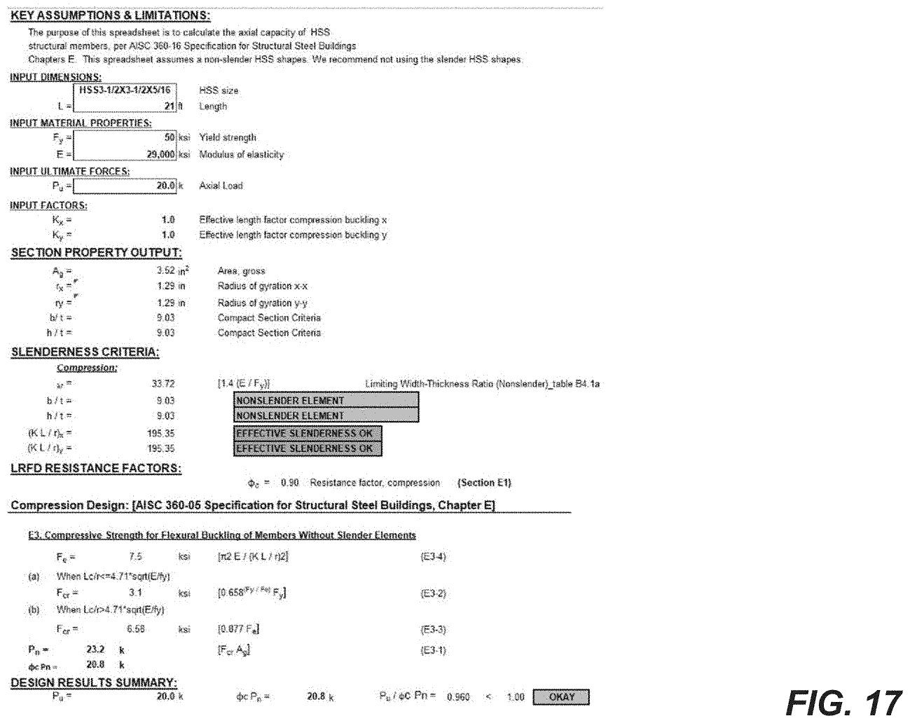

At step 675 the system sets the size and price of all the primary, secondary, and tertiary structural members based on the structural loading. FIG. 8 shows an example of this structural hierarchy. The wiring 5302 is tertiary. The structural elements 5303 and 5304 are secondary, and the further support elements 5305 are Primary. First, any environmental loading data (wind load, seismic loading, snow-loading, live-loads, dead-loads) may be defined manually or automatically in the form of Pounds-Per-Square-Foot PSF. The loading for each member is then divided along up according to proximate loading support ratios. In the process of adjusting the structure size and geometry, the individual structural members may change in length, thus effecting their loading capacity. See FIG. 16. These loads are converted into tension, compression, or axial loads in kips (kip-force/square inch) as assigned to the structural members and locations. See FIG. 17 for an example calculation. The force numbers for each member are then cross-referenced in a structural catalog according to the lightest structural member that can accommodate the force input with a prescribed margin of safety. See FIG, 18. The final step is to price the defined structural pieces according to size and associated labor statistics at step 700.

Step 700: Installed System Cost Estimator. At this step, the system reads the concluding structural information from step 500, and the PV electrical schematics gathered at step 650, for any particular design configuration and applies the materials costs for each element by type and volume. The costs may be held in a data bank which has up-to the year costs for the applicable construction material, trade labor rates, PV panel type, wire size, and transformer.

Calculating the construction material costs may be performed by calculating the length, volume, quantity, and type of materials and linking those to a standardized pricing database, such as the RS-Means® index using the Master-Format® indexing system, for example. Each component price may include both the material cost and associated labor costs. Each material system, system of components may be added up to a total structure and electrical system cost which typically is the largest factor that feeds into the Cᵢₙᵢₜᵢₐₗ (initial cost) of the LCOE equation. In some embodiments, the system may obtain real time pricing information including, as a non-limiting example, real time commodity spot prices for structural materials, or other commodities whose prices are correlated to expected construction costs. The user may also input their own estimated or historical costs into a formatted machine-readable database.

Step 800: Solar Energy Calculations. At this step solar energy calculations may be performed by first drawing on the database of available solar panel models and selecting the lowest $/watt panel, then loading in the dimensional size of the panel. This dimensional size then stretches the structural module size to accommodate those dimensions. This dimensional data may then be set to fit into a structural bay that is framed by vertical and horizontal primary supports of the structural typology.

We now discuss two example methods of calculating the power production, a precise method and a faster less processor-intensive method. In the precise method, the number of panels, orientation, and self-shading, are fed into a solar calculation algorithm such as the open-source solar calculation algorithm supplied by NREL-SAM, as a non-limiting example. The geographic-centric historic weather data may also be fed into this NREL-SAM calculator. The NREL-SAM algorithm may then be used to calculate the amount of energy generated per year (accounting for the entire year worth of weather data, hour-by-hour, sun-hours, and sun intensity) for each panel individually and adding that up for the bay.

In the faster method, the number of panels, orientation, and self-shading, are fed into another solar calculation algorithm such as the solar calculation algorithm supplied by the open source Ladybug package, as a non-limiting example. The geographic-centric historic weather data may also be fed into this Ladybug calculator. The Ladybug algorithm or any other suitable algorithm may then then be used to estimate the amount of energy generated per year for each panel individually and adding that up for the bay.

The next step is to multiply the number of bays until the intended overall system footprint size, desired maximum DC nameplate power generation, or budget allocation goals are reached. The orientation of the panels in relation to the sun and in relation to obstructions that cast shadows, such as the structure and panel row spacing may be specified. These physical characteristics are then analyzed by a sun radiance process which applies the weather data using the physical system characteristics mentioned earlier.

If each bay has a different orientation, tilt (5102, 5103, 5126, 5502) or environmental shading characteristic, then those bays may be calculated separately again after the self-shading optimizer 600 has set those orientations.

Step 900: Levelized Cost of Energy ($/W) calculation. Levelized cost of energy (LCOE) may be calculated as follows LCOE=((Cᵢₙᵢₜᵢₐₗ/PWF)+CO&M)/Esolar. Cᵢₙᵢₜᵢₐₗ is the initial cost of the PV system. PWF is the Present Worth Factor. C_{O&M} is the Annual Operation and maintenance cost (Typically Cᵢₙᵢₜᵢₐₗ*0.35%), and Eₛₒₗₐᵣ is the Total annual energy delivery.

The Present Worth Factor is an equation that integrates the inflation rate of the dominant currency, the discount rate, which is based upon the interest rate of a financial loan for the system, and loan term in years. The PWF may be calculated as follows: PWF=(1+i)(1+d)1−1+i1+dN. The variable i is the inflation rate (e.g. 2.25%). The variable d is the discount rate for the loan used to finance project (e.g., 9%), and N is the number of years for the project (or the applicable loan term, e.g., 25 years). Operations and Maintenance Cost is a singular number which is based upon a fraction of the initial construction cost. This number can be derived from empirical precedent or a database of similar projects historical O&M costs.

Total annual energy (kWH/yr.) will be the result of a solar radiation analysis of the designed system's photovoltaic efficiency and the supporting structure(s) geometry calculated over the course of a typical year's. The angle, azimuth, elevation, spacing, and shading of the PV panels along with local historical weather data, inverter efficiency, and solar panel data is used to simulate solar radiance over time, and the conversion of solar energy into electrical energy. Weather data may be obtained in the Energy Plus weather format, or in any other suitable format. EPW weather data reader. Solar panel characteristics may be obtained from the NREL solar panel specification database or any other suitable data source. Changes made to the angle of PV panels, orientation, shape and geometry of a structure may be used to immediately generate updated power generation results. These results are then fed back into the LCOE calculation as Eₛₒₗₐᵣ, the total annual energy delivery estimate.

The typical initial costs of the system consist of site costs, engineering, structure materials, construction labor, photovoltaic panels, electrical system, inverter, connection fee, and administrative costs. This data defined and input from ‘500 & 650 Installed System Cost Estimator.

Step 1000: System Optimization. An example system optimization module can be implemented to apply incremental changes and check for improvements or may employ a stochastic optimization solver (using the Nelder-Mead method, as a non-limiting example) that informs a machine-learning/genetic optimization script. This module is tasked with finding the lowest possible LCOE or $/W number by analyzing and comparing the aggregate change when input factors are changed. The inputs that are to be changed for optimization are the ‘100 Initial structural parameters’ and ‘200 PV Solar data’, and subsequently the following modules to be re-calculated 500, 600, 650, 700, 800, and 900. The process is to start with large changes and variables using large random variables, then when multiple low price solutions are identified, a simulated annealing process is done for fine-tuning the variables for each solution.

The steps of the example process 10 may be performed as part of a feedback loop, as follows. After steps 100-900 are performed, the system may employ the optimization model to vary characteristics of an initial system design in order to further optimize for costs, energy output, or a fitness score such as LCOE (or any other suitable metric). In subsequent, iterations, the system may assess alternative structure types and/or alternative PV panel options at steps 100, 200. At step 500, the panel angles may be varied (see step 500) to determine the impact on power generation and costs. At step 600 panel spacing may be adjusted for consistency with previous angle and geometry changes. At steps 650, 675 necessary changes to wiring and structural components are determined. At step 900, the system recalculates LCOE based on changes in Cᵢₙᵢₜᵢₐₗ resulting from design modifications. The optimization input selections and substitutions can be as broad as changing structure type altogether such as in module 1, comparing a thin-shell structure against a truss-based structure, or in module 2, comparing solar panel types such as Thin-film panels to mono-crystalline rigid panels.

Once a suitably optimized structure is found, the system may, at step 1200 stored learned optimized Lowest LCOE for given configurations. These learned LCOE values may be used by the system to inform optimization of designs for similar sites in the future.

What is claimed is:

1. A system for designing an optimized structure supporting photovoltaic panels for placement at a selected site comprising a processor and memory, the memory storing executable instructions that, when executed by the processor, cause the system to:
receive an energy output specification indicating a desired minimum level of electrical energy to be produced by the photovoltaic panels;
receive geographic information for the selected site that indicates portions of the selected site to be spanned by the optimized structure and historical climate data for the selected site;
generate an initial system design by:
selecting, for each portion of the selected site to be spanned, a structure design template describing a first structure type suitable for spanning that portion of the selected site;
determining, for each portion of the selected site to be spanned, dimensions of a respective structural unit of having the first structure type, suitable to span that portion of the selected site;
determining a corresponding arrangement of photovoltaic panels mountable on each respective structural unit capable of providing the desired minimum level of electrical energy at the selected site while mounted on the respective structural units;
calculating estimated structural loading of each respective structural unit when supporting the corresponding arrangement of photovoltaic panels for that structural unit;
determining materials for each respective structural unit required to support the arrangements of photovoltaic panels for that structural unit;
calculate a value of a fitness score for the initial system design by:
calculating, using the geographic information and the historical climate data for the selected site, a total expected energy output for the initial system design by summing expected energy outputs of the arrangements of photovoltaic panels for each portion of the selected site to be spanned according to the initial system design;
calculating an expected cost of constructing the initial system design; and
producing, as the value of the fitness score for the initial system design, a numerical score representing a ratio of the expected cost of constructing the initial design to the total expected energy output for the initial system design;
and
perform genetic optimization of the initial system design to determine an optimized system design to support the photovoltaic system, the optimized system design having a value of the fitness score that is less than the value of a fitness score for the initial system design.

2. The system of claim 1, wherein, when the system performs the genetic optimization of the initial system design, execution of the instructions by the processor causes the system to perform a modification procedure that includes:
varying a dimension or position of one or more component of at least one structural component belonging to one or more structural unit of the initial system design to produce a modified system design;
calculating a value of the fitness score for the modified system design by:
calculating, using the geographic information and the historical climate data for the selected site, a total expected energy output for the initial system design by summing expected energy outputs of the arrangements of photovoltaic panels for each portion of the selected site to be spanned according to the modified system design;
calculating, an expected cost of constructing the modified system design; and
producing, as the value of the fitness score for the modified system design, a numerical score representing a ratio of the expected cost of constructing the initial design to the total expected energy output for the initial system design;
and
repeatedly performing the modification procedure using the modified system design in place of the initial system design.

3. The system of claim 2, wherein, when the system performs the genetic optimization of the initial system design, execution of the instructions by the processor further causes the system to:
determine that the value of the fitness score for the modified system design is greater than or equal to the value of the fitness score for the initial system design of a previous iteration of the modification procedure; and
replace one or more structural units having the first structure type in the modified structural design with structural units having a second structure type defined by a second structure design template.

4. The system of claim 1, wherein performing the genetic optimization of initial system design designs includes estimating the cost of a structural design based on the size of the structural design by:
selecting one or more pre-defined structural members according to the amount of structural forces acting upon each member using a pre-selected database of members based on safe structural capacity ratings; and
determining costs of the one or more pre-defined structural members, the costs including associated labor costs obtained from industry databases or empirical data.

5. The device of claim 4, wherein performing the genetic optimization of initial system design further comprises altering one or more structural units of the initial system design in response to one of the following characteristics: complexity of joints, construction difficulty, and logistical constraints.

6. The system of claim 4, wherein the memory stores instructions that, when executed by the processor, cause the system to:
retrieve the initial structural design from a database storing previous optimized structural designs for sites similar to the selected site having similar constraints to the one or more economic constraints and the one or more physical constraints for the selected site.

7. The system of claim 1, wherein the memory stores instructions that, when executed by the processor, cause the system to automatically space photovoltaic panels of the photovoltaic system to avoid self-shading by:
using a recursive optimizer to create and detect shadows caused by photovoltaic panels of the photovoltaic closest to the equator and working away, spacing each panel or set of panels optimally; and
wherein the recursive optimizer performs calculations with respect to a locally-optimal center-line that chosen for each photovoltaic panel or set of photovoltaic panels.

8. The system of claim 1, wherein the memory stores instructions that, when executed by the processor, cause the system to automatically configure a wiring system across linear and proximate photovoltaic panel placements with similar sun exposure characteristics, wherein configuring the wiring system includes:
adding up the voltage of each photovoltaic panel in a series string until an optimal inverter feed-in voltage rating is met;
automatically sizing connecting wires, feeder, and trunk lines to an optimal allowable size based on voltage and amperage;
finding the shortest distance and minimal use of overall wiring and component cost by applying a default preferred configuration as a starting point and adjusting variables as the structure size and geometry inputs changes;
using properties of wire length, metal wire type, and component specifications, finding the approximate system energy loss as an output factor for use in calculating values of the fitness score for the initial system design and modified system designs; and
using a pricing system to sum costs all DC electrical equipment, wiring, and associated labor for use in calculating the values of the fitness score for the initial system design and modified system designs.

9. The system of claim 8, wherein the memory stores instructions that, when executed by the processor, cause the system to employ stochastic solving to compare component and wiring options to find a most cost-effective set of wiring specifications.

10. A computer-implemented method of designing an optimized structure supporting photovoltaic panels for placement at a selected site, the method comprising:
receiving an energy output specification indicating a desired minimum level of electrical energy to be produced by the photovoltaic panels;
receiving geographic information for the selected site that indicates portions of the selected site to be spanned by the optimized structure and historical climate data for the selected site;
generating an initial system design by:
selecting, for each portion of the selected site to be spanned, a structure design template describing a first structure type suitable for spanning that portion of the selected site;
determining, for each portion of the selected site to be spanned, dimensions of a respective structural unit of having the first structure type, suitable to span that portion of the selected site;
determining a corresponding arrangement of photovoltaic panels mountable on each respective structural unit capable of providing the desired minimum level of electrical energy at the selected site while mounted on the respective structural units;
calculating estimated structural loading of each respective structural unit when supporting the corresponding arrangement of photovoltaic panels for that structural unit;
determining materials for each respective structural unit required to support the arrangements of photovoltaic panels for that structural unit;
calculating a value of a fitness score for the initial system design by:
calculating, using the geographic information and the historical climate data for the selected site, a total expected energy output for the initial system design by summing expected energy outputs of the arrangements of photovoltaic panels for each portion of the selected site to be spanned according to the initial system design;
calculating, an expected cost of constructing the initial system design; and
producing, as the value of the fitness score for the initial system design, a numerical score representing a ratio of the expected cost of constructing the initial design to the total expected energy output for the initial system design;
and
performing genetic optimization of the initial system design to determine an optimized system design to support the photovoltaic system, the optimized system design having a value of the fitness score that is less than the value of a fitness score for the initial system design.

11. The method of claim 10, wherein performing the genetic optimization of the initial system design comprises performing a modification procedure that includes:
varying a dimension or position of one or more component of at least one structural component belonging to one or more structural unit of the initial system design to produce a modified system design;
calculating a value of the fitness score for the modified system design by:
calculating, using the geographic information and the historical climate data for the selected site, a total expected energy output for the initial system design by summing expected energy outputs of the arrangements of photovoltaic panels for each portion of the selected site to be spanned according to the modified system design;
calculating, an expected cost of constructing the modified system design; and
producing, as the value of the fitness score for the modified system design, a numerical score representing a ratio of the expected cost of constructing the initial design to the total expected energy output for the initial system design; and
repeatedly performing the modification procedure using the modified system design in place of the initial system design.

12. The method of claim 11, wherein performing the genetic optimization of the initial system design further comprises:
determining that the value of the fitness score for the modified system design is greater than or equal to the value of the fitness score for the initial system design of a previous iteration of the modification procedure; and
replacing one or more structural units having the first structure type in the modified structural design with structural units having a second structure type defined by a second structure design template.

13. The method of claim 10, wherein performing the genetic optimization of the one or more structural designs includes estimating the cost of a structural design based on the size of the structural design by:
selecting one or more pre-defined structural members according to the amount of structural forces acting upon each member using a pre-selected database of members based on safe structural capacity ratings; and
determining costs of the one or more pre-defined structural members, the costs including associated labor costs obtained from industry databases or empirical data.

14. The method of claim 13, wherein performing the genetic optimization of initial system design further comprises altering one or more structural units of the initial system design in response to one of the following characteristics: complexity of joints, construction difficulty, and logistical constraints.

15. The method of claim 13, the method further comprising retrieving the initial structural design from a database storing previous optimized structural designs for site similar to the selected site having similar constraints to the one or more economic constraints and the one or more physical constraints for the selected site.

16. The method of claim 10, the method further comprising automatically spacing photovoltaic panels of the photovoltaic system to avoid self-shading by:
using a recursive optimizer to create and detect shadows caused by photovoltaic panels of the photovoltaic closest to the equator and working away, spacing each panel or set of panels optimally; and
wherein the recursive optimizer performs calculations with respect to a locally-optimal center-line that chosen for each photovoltaic panel or set of photovoltaic panels.

17. The method of claim 10, the method further comprising automatically configuring a wiring system across linear and proximate photovoltaic panel placements with similar sun exposure characteristics, wherein configuring the wiring system includes:
adding up the voltage of each photovoltaic panel in a series string until an optimal inverter feed-in voltage rating is met;
automatically sizing connecting wires, feeder, and trunk lines to an optimal allowable size based on voltage and amperage;
finding the shortest distance and minimal use of overall wiring and component cost by applying a default preferred configuration as a starting point and adjusting variables as the structure size and geometry inputs changes;
using properties of wire length, metal wire type, and component specifications, finding the approximate system energy loss as an output factor for use in calculating values of the fitness score for the initial system design and modified system designs; and
using a pricing system to sum costs all DC electrical equipment, wiring, and associated labor for use in calculating the values of the fitness score for the initial system design and modified system designs.

18. The method of claim 17, the method further comprising employing stochastic solving to compare component and wiring options to find a most cost-effective set of wiring specifications.
